(19) United States
(12) Patent Application Publication
(10) Pub. No.: US 2018/0276581 A1
(43) Pub. Date: Sep. 27, 2018

(54) INFORMATION PROCESSING APPARATUS

(71) Applicant: FUJI XEROX CO., LTD., Tokyo (JP)

(72) Inventors: Kimiko SAKURAI, Kanagawa (JP); Kazunori HORIKIRI, Kanagawa (JP)

(73) Assignee: FUJI XEROX CO., LTD., Tokyo (JP)

(21) Appl. No.: 15/918,430

(22) Filed: Mar. 12, 2018

(30) Foreign Application Priority Data
Mar. 22, 2017 (JP) 2017-055218

(51) Int. Cl. G06Q 10/06; G06Q 10/10

(52) U.S. Cl. CPC G06Q 10/0633; G06Q 10/10

(57) ABSTRACT

An information processing apparatus includes a receiver, a processing unit, and a transmitter. The receiver is configured to receive, as a task, a sticky note that can be pasted on a mount. The processing unit is configured to process the sticky note on the mount. The transmitter is configured to transmit the processed sticky note to a person who is in charge of a task indicated by the sticky note.

### CROSS-REFERENCE TO RELATED APPLICATIONS

This application is based on and claims priority under 35 USC 119 from Japanese Patent Application No. 2017-055218 filed Mar. 22, 2017.

### BACKGROUND

### Technical Field

The present invention relates to an information processing apparatus.

### SUMMARY

According to an aspect of the invention, an information processing apparatus includes a receiver, a processing unit, and a transmitter. The receiver is configured to receive, as a task, a sticky note that can be pasted on a mount. The processing unit is configured to process the sticky note on the mount. The transmitter is configured to transmit the processed sticky note to a person who is in charge of a task indicated by the sticky note.

### BRIEF DESCRIPTION OF THE DRAWINGS

Exemplary embodiments of the present invention will be described in detail based on the following figures, wherein:

FIG. 1 is a conceptual module configuration diagram illustrating a configuration example of the present exemplary embodiment;

FIG. 2 is an explanatory view illustrating a system configuration example using the present exemplary embodiment;

FIGS. 3A to 3C are explanatory views illustrating a use example of an electronic sticky note terminal and an electronic sticky note control apparatus in a conference room or the like in which the present exemplary embodiment is used;

FIG. 4 is a flowchart illustrating a process example according to the present exemplary embodiment;

FIG. 5 is an explanatory view illustrating a data structure example of task information;

FIG. 6 is an explanatory view illustrating a data structure example of a sticky note information table;

FIG. 7 is an explanatory view illustrating a data structure example of sticky note task information;

FIG. 8 is an explanatory view illustrating a data structure example of a mount information table;

FIG. 9 is an explanatory view illustrating a process example according to the present exemplary embodiment;

FIG. 10 is an explanatory view illustrating a process example according to the present exemplary embodiment;

FIG. 11 is an explanatory view illustrating a process example according to the present exemplary embodiment;

FIG. 12 is an explanatory view illustrating a process example according to the present exemplary embodiment;

FIG. 13 is a flowchart illustrating a process example according to the present exemplary embodiment;

FIG. 14 is an explanatory view illustrating a process example according to the present exemplary embodiment; and

FIG. 15 is a block diagram illustrating a hardware configuration example of a computer that implements the present exemplary embodiment.

### DETAILED DESCRIPTION

Hereinafter, an exemplary embodiment suitable for implementing the present invention will be described with reference to the accompanying drawings.

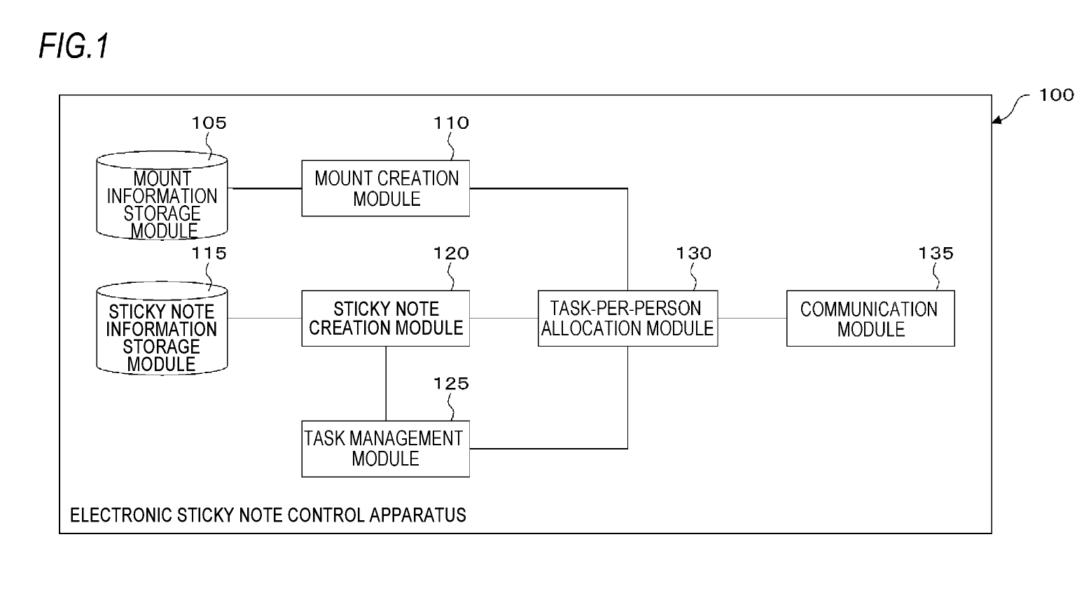

FIG. 1 illustrates a conceptual module configuration diagram of a configuration example of the present exemplary embodiment.

A module, in general, indicates a logically separable component such as software (computer program) or hardware. Accordingly, a module in the present exemplary embodiment indicates not only a module in a computer program but also a module in a hardware configuration. Thus, the descriptions of the present exemplary embodiment also include descriptions of a computer program to serve as a module (a program that causes a computer to execute respective processes, a program that causes a computer to serve as respective units, and a program that causes a computer to implement respective functions), a system, and a method. For convenience of descriptions, the expressions “store,” “caused to store,” and equivalent expressions thereto will be used. If an exemplary embodiment is directed to a computer program, the expressions indicate storing data or the like in a memory device or performing a control to cause data or the like to be stored in a memory device. In addition, one module may correspond to one function. In implementation, however, one module may be configured with one program, plural modules may be configured with one program, and in reverse, one module may be configured with plural programs. Further, plural modules may be executed by one computer, or one module may be executed by plural computers in a distributed or parallel environment. In addition, one module may include another module. Hereinafter, the term “connection” is also used for a logical connection (for example, data exchange, instructions, and a reference relationship among data), in addition to a physical connection. The term “predetermined” refers to being determined prior to a target process. The term “predetermined” includes the meaning of being determined according to a circumstance/state at or until a specific time point not only before a process by the present exemplary embodiment is started, but also prior to a target process even after a process by the present exemplary embodiment is started. If there are plural “predetermined values”, the predetermined values may be different from each other, or two or more (may include all, of course) of the predetermined values may be the same. In addition, the description “when it is A, B is performed” indicates that “it is determined whether it is A, and if it is determined that it is A, B is performed,” except for a case where it is unnecessary to make the determination as to whether it is A. If items are enumerated like “A, B, and C,” the enumeration is merely exemplary and includes a case of selecting only one (for example, only A) of the items, unless otherwise specified.

In addition, a system or device includes a system or device which is implemented by one computer, hardware component, device or the like, in addition to a system or device configured such that plural computers, hardware components, devices and the like are connected to each other by a communication unit such as a network (including a one-to-one corresponding communication connection). The terms “device” and “system” are synonymous with each other. Of course, the “system” does not include a mere system indicating a social “structure” (social system) which is an artificial engagement.

In addition, target information is read from a memory device per process by each module or for each of plural processes which are executed in a module. After the process is executed, the process result is written in the storage device. Therefore, the description of reading of information from the memory device before a process or writing of information to the memory device after a process may be omitted. The storage device here may include a hard disk, a random access memory (RAM), an external recording medium, a storage device using a communication line, a register in a CPU, and the like.

An electronic sticky note control apparatus 100 (an example of an information processing apparatus) according to the present exemplary embodiment performs a process relating to mounts and sticky notes (also referred to as electronic sticky notes and electronic cards) which are used in a gathering. As illustrated in the example of FIG. 1, the electronic sticky note control apparatus 100 includes a mount information storage module 105, a mount creation module 110, a sticky note information storage module 115, a sticky note creation module 120, a task management module 125, a task-per-person allocation module 130, and a communication module 135. The term “gathering” may refer to an event where plural people meet together for conversation and may include, for example, a conference, a workshop, an idea extraction meeting, a review meeting, a consultation, a discussion, an assembly, and a meeting. The present exemplary embodiment relates to an electronic sticky note system (also referred to as an electronic whiteboard or the like) using electronic sticky notes and mounts.

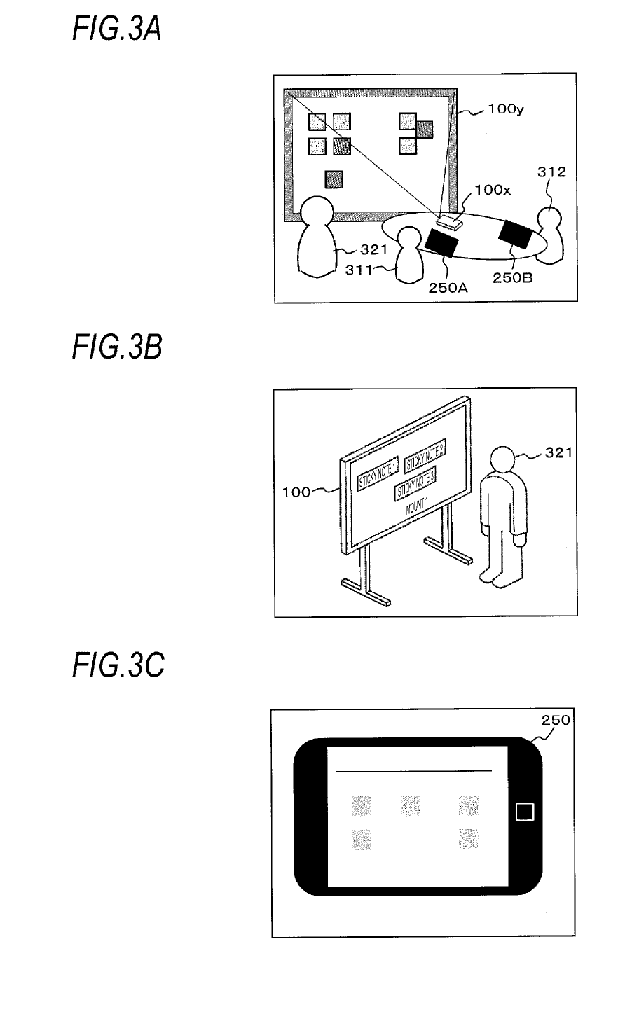

Specifically, the electronic sticky note control apparatus 100 is used in a gathering, which is performed by a facilitator (generally one person) and plural participants using sticky notes. Each participant creates a sticky note, on which ideas and the like are written, using an electronic sticky note terminal 250 as a participant terminal. Generally, as illustrated in examples of FIGS. 3A to 3C, there are plural electronic sticky note terminals 250, such as an electronic sticky note terminal 250A and an electronic sticky note terminal 250B, possessed by the respective participants (hereinafter representatively referred to as the electronic sticky note terminals 250). In addition, the electronic sticky note control apparatus 100 receives sticky notes from the electronic sticky note terminals 250 and pastes the received sticky notes on the mount (or the background). The facilitator uses a shared screen which is a display device of the electronic sticky note control apparatus 100 to determine or change the positions of the sticky notes on the mount, combine the sticky notes (also referred to as “associates a first sticky note and a second sticky note with each other”, “forming a group”, or the like), to create sticky note information by him/herself, thereby progressing the gathering. In addition, in the present exemplary embodiment, the facilitator is included in the participants.

The electronic sticky note control apparatus 100 controls an electronic sticky note system, and in particular, is used as a project management tool.

For example, in a gathering for extracting problems, an operation of pasting a sticky note on a mount is performed using the electronic sticky note system. As an output of the gathering, that is a countermeasure against the problem, a task (work) that needs to be performed next may be extracted in a project. The term “task” refers to a combination of one or more works and one delivery date.

However, it is impossible for an electronic sticky note system of the related art to manage tasks using sticky notes on mounts.

Meanwhile, web services such as a work breakdown structure (WBS) or a team foundation server (TFS) are often used for the management of a project. In these services, tasks are determined in advance, and it is necessary to determine tasks and schedule which are to be managed at the beginning of the project. In addition, it is necessary to manage attributes such as an upper level requirement, a person in charge, a work period, and the like for each task.

In addition, a worker needs to do the followings.
Register him/herself as a worker of a task object to be performed, and input a work period.
Record work contents every day.
Input the current progress as a percentage (%) or remaining days.

In addition, a manager needs to do the followings.
Daily check the progress rate for a set of tasks to be managed.
Extract a task in which a problem has occurred and take an appropriate countermeasure.
Allocate a resource to a task to which no person in charge has not allocated.

For example, when an unexpected task has occurred, the followings may occur.
A work of registering task interruption occurs, which is troublesome.
It is necessary to correlate (associate) the added task to (with) a related task, which requires adjustment of a workload and a work period.
For these reasons, an unscheduled task may be processed at the level of a person in charge without being registered in a management system, which causes missing of a work or a deliverable.

In addition, for example, when update of the progress is delayed, the followings may occur.
When the progress of each worker is not updated to the management system on a daily basis, the management system is meaningless. However, for a worker, the act of inputting management attributes to the management system is just costly (costly without merits for the worker). Therefore, the update is postponed, and the manager may not grasp the accurate progress status.
When task management, communication tools (for example, mails), management of deliverables (document storage location) are managed separately, it is a very burdensome for a worker who inputs them.

Therefore, when it is attempted to create a task management system that is easily managed, input of data by workers increases, and unbalance between the manager's effort and the worker's effort easily occurs.

The electronic sticky note control apparatus 100 expresses a task as a sticky note and expresses the flow of the task by exchanging the sticky note, thereby implementing a flexible management system. The electronic sticky note control apparatus 100 becomes a system in which either input or output (display) is labor-free.

The mount information storage module 105 is connected to the mount creation module 110. The mount information storage module 105 stores information on a mount. For example, the mount information storage module 105 stores a mount information table 800 illustrated in an example of FIG. 8 to be described later, and the like.

The mount creation module 110 is connected to the mount information storage module 105 and the task-per-person allocation module 130. The mount creation module 110 selects a mount pattern, which is a format, according to an operation of an operator, and creates a mount to be used in a gathering. For example, when a mount pattern for task management is selected, portrait icons of gathering participants are drawn.

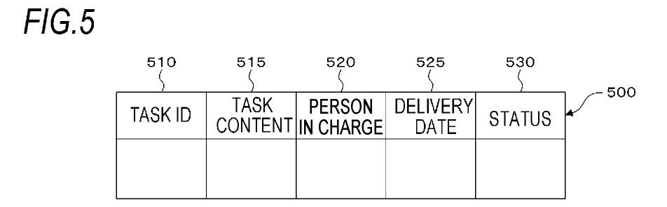

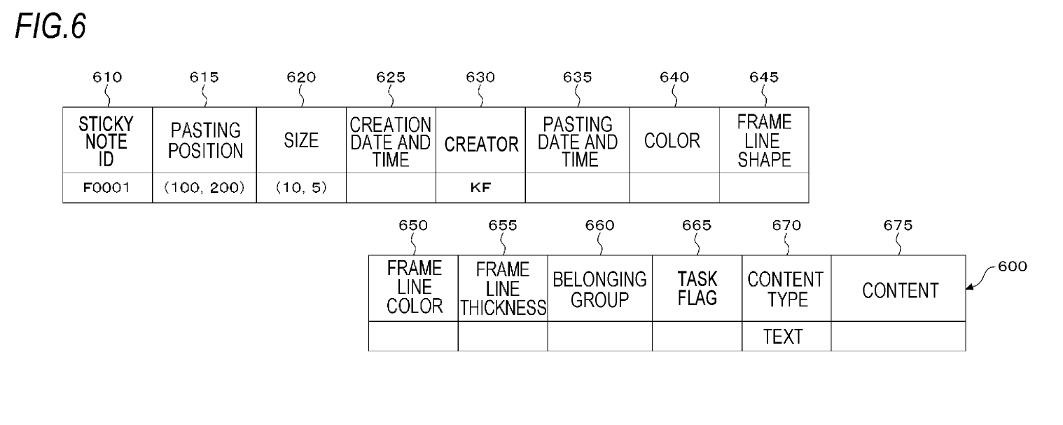

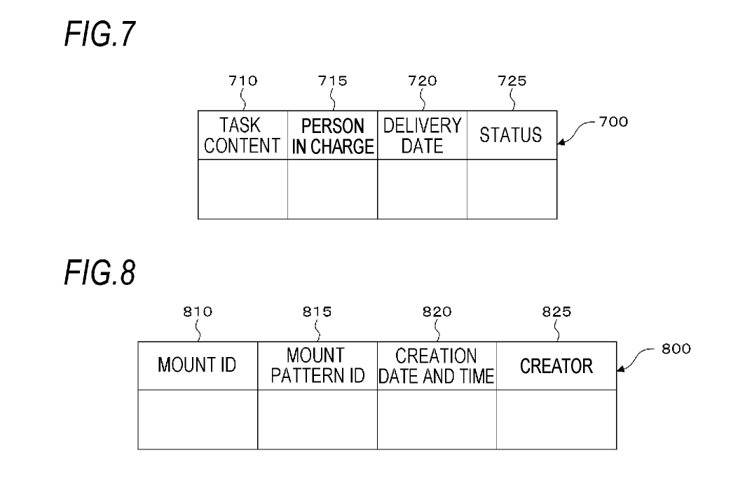

The sticky note information storage module 115 is connected to the sticky note creation module 120. The sticky note information storage module 115 stores information on sticky notes and information on tasks. For example, the sticky note information storage module 115 stores task information 500 illustrated in FIG. 5, a sticky note information table 600 illustrated in an example of FIG. 6, a sticky note task information 700 illustrated in the example of FIG. 7, and the like which will be described later.

The sticky note creation module 120 is connected to the sticky note information storage module 115, the task management module 125, and the task-per-person allocation module 130. The sticky note creation module 120 receives a sticky note operation by a facilitator or the like and performs a process in accordance with the operation. Here, the operation includes, for example, creation of a sticky note, movement/copying of a sticky note, enlargement/reduction of a sticky note, alteration of attributes (for example, color) of a sticky note, grouping, or the like. In addition, an operation of correlating a sticky note and a task to each other, an operation of determining a person in charge of a task, and the like are performed.

The task management module 125 is connected to the sticky note creation module 120 and the task-per-person allocation module 130. The task management module 125 receives a sticky note which can be pasted on the mount, as a task. For example, the sticky note may be a sticky note that is created by the sticky note creation module 120, or may be a sticky note that has already been pasted on the mount.

The task-per-person allocation module 130 is connected to the mount creation module 110, the sticky note creation module 120, the task management module 125, and the communication module 135. The task-per-person allocation module 130 processes the sticky note which has received as a task by the task management module 125, on the mount. Here, the sticky note with which the task is associated has a function as a job ticket.

For example, the task-per-person allocation module 130 may perform a process of dividing a task by dividing a sticky note into new sticky notes. The division of the sticky note may be performed in accordance with a user's operation. The division of the sticky note is to create so-called subtasks. For a specific process of dividing the sticky note, a command such as “Divide” or “Create a subtask” may be explicitly prepared. In addition, when the user instructs a command to newly create a sticky note in a state where the user has pointed a sticky note that indicates a certain task, the task-per-person allocation module 130 may perform a process of dividing a sticky note such that the pointed sticky note serves as a master task and the newly created sticky notes serves as subtasks.

In addition, a delivery date (including a deadline, a due date, or the like) is generally set to a task. Delivery dates of tasks that correspond to sticky notes created by the division may be determined in accordance with the delivery date of the task that corresponds to the division source sticky note. For example, the delivery date of the task that corresponds to the division source sticky note may be used as it is, or any date a predetermined period before the delivery date may be used as the delivery date of the tasks that correspond to the sticky notes created by the division. In addition, if it is necessary to sequentially process the tasks corresponding to the sticky notes created by the division, the delivery date of each task may be set in accordance with a required process period of the task. For example, if an original task is divided into a task A and a task B and the task A and the task B need to be processed in this sequence, the delivery date of the task B may be the same as the delivery date of the original task, and the delivery date of the task A may be a date which provides a required process period of the task B (specifically, the date the required process period of the task B before the delivery date of the original task).

In addition, the task-per-person allocation module 130 may display the progress status of a task that corresponds to a sticky note transmitted by the communication module 135. For example, the progress status may be displayed as the content of a sticky note pasted on amount (the sticky note transmitted by the communication module 135).

Then, the displayed progress status may include the number of sticky notes (that corresponds to the number of tasks) associated with a target task and a residence time. Here, the residence time may be an elapsed time since a sticky note is transmitted to a person in charge (since a task is allocated to the person in charge) or may be an elapsed time after a process period allocated to the task expires (so-called delay time).

In addition, the task-per-person allocation module 130 may allow return to a master task by merging plural sticky notes (sticky notes of sibling tasks) with which a subtask is associated. That is, when the merging operation that is reverse to the division operation is detected, the task-per-person allocation module 130 may display a message indicating that the tasks of the sticky notes created by the division have been completed, on a sticky note that is a master task.

In addition, when an operation of moving a sticky note toward an object that indicates a user is detected, the task-per-person allocation module 130 may set the user indicated by the object as a person in charge of a task that corresponds to the moved sticky note.

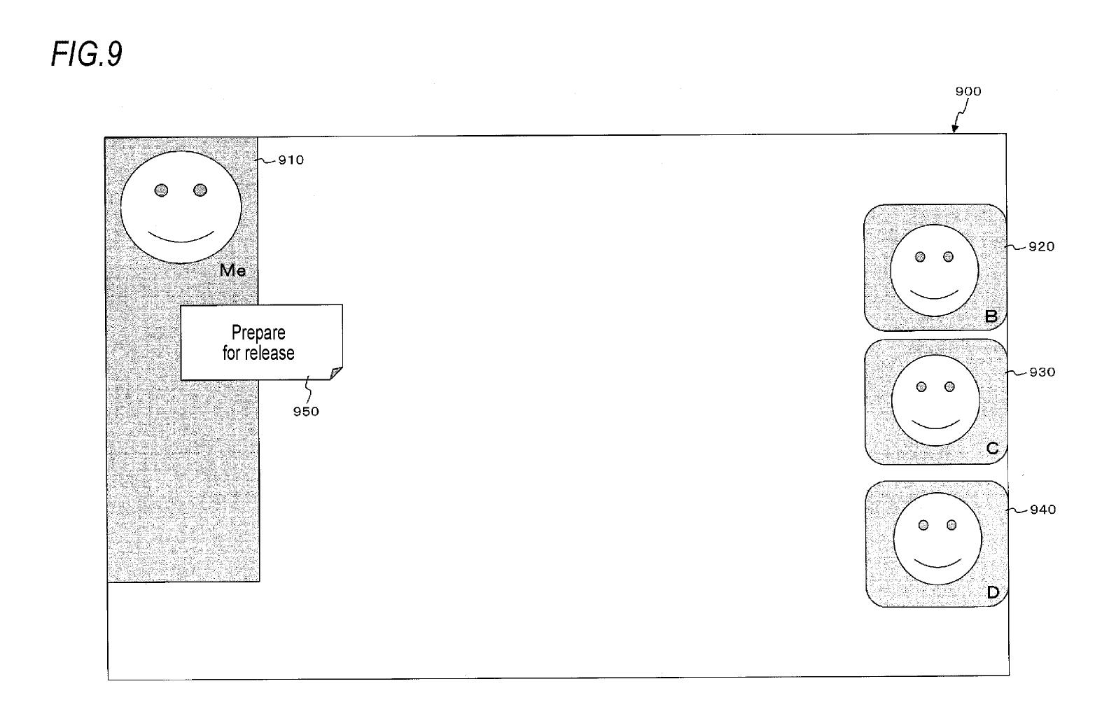

In order to provide intuitive task management, an intuitive graphical user interface (GUI) is used. The phrase “object that indicates the user” herein includes an image such as an icon on which a portrait is drawn or a photograph, texts of user names, or the like. For example, the above-described operation corresponds to an operation of placing an icon of a user (a person who may be in charge of a task) on a mount and moving a sticky note (a sticky note to which a task is assigned) to the area of the icon. Specifically, for example, in a mount 900 illustrated in FIG. 9, in response to an operation of moving a task sticky note 950 of “Prepare for release” on the left side to the icon of a user B (a member B area 920), a process of requesting the user B to perform a task that corresponds to the task sticky note 950 is performed.

Moreover, the task-per-person allocation module 130 may display a sticky note that indicates a task possessed by a user, within a predetermined range from an object that indicates the user. Here, examples of the expression “within the predetermined range” includes (i) within an area of the object that indicates the user, (ii) a part of the sticky note is included in the area (that is, the sticky note appears to be pasted in the area), and (iii) the sticky note is located within a predetermined distance from the area of the object that indicates the user.

For a sticky note corresponding to a task for which concurrent working is possible, the task-per-person allocation module 130 may allow a copy operation by which two or more identical sticky notes are created. Whether or not concurrent working is possible is determined using information defined in a task content column 710 of the sticky note task information 700 which will be described later.

In addition, the task-per-person allocation module 130 may record an exchange date and time and a change of the person in charge in response to a copy operation and a moving operation of a sticky note with which a task is associated, and may notify a concerned person of the same. The concerned persons may be a sticky note movement destination (copy destination), a person in charge as the movement source (copy source), an administrator, or the like.

In addition, achievement conditions of a task include a deliverable and a delivery date and may be edited by a user. That is, a task is patterned, a task as an object-oriented class exists, and a task instance is edited and used as an optimum value for each time.

In addition, the task-per-person allocation module 130 may grasp the state of a task by tracing exchange of a sticky note.

The communication module 135 is connected to the task-per-person allocation module 130. The communication module 135 transmits a sticky note processed by the task-per-person allocation module 130 to a person who is in charge of the task indicated by the sticky note. Any transmission method may be adopted as long as it is capable of transmitting a sticky note to a person in charge. Examples of the transmission method include an electronic mail, pasting on a personal mount managed by a person in charge, chatting, an electronic bulletin board, notification using a social media, and a push notice.

In addition, the communication module 135 may transmit a sticky note divided by the task-per-person allocation module 130 to a person who is in charge of a task indicated by the sticky note.

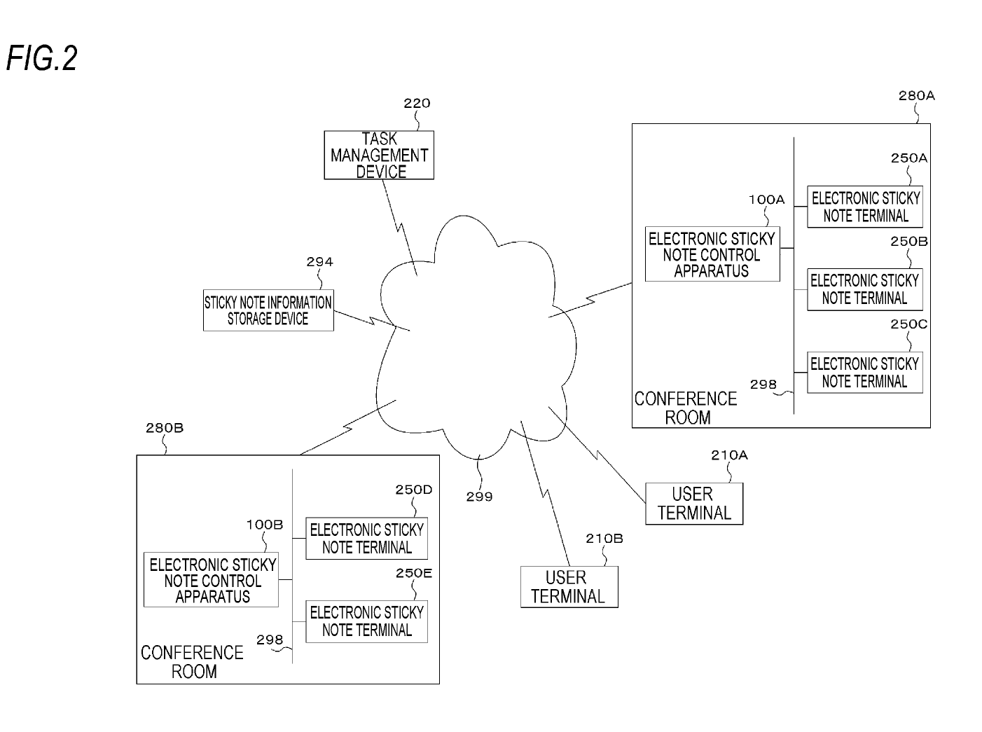

FIG. 2 is an explanatory view illustrating a configuration example of a sticky note system using the present exemplary embodiment. The electronic sticky note control apparatus 100 generally includes a large-screen display device and is operated by a facilitator. The display device is visible to all participants. Each electronic sticky note terminal 250 is operated by a participant at a gathering. Generally, each participant possesses one electronic sticky note terminal 250. For example, a tablet-type terminal or the like may be used as the electronic sticky note terminal 250.

In the example of FIG. 2, an electronic sticky note control apparatus 100A, an electronic sticky note terminal 250A, an electronic sticky note terminal 250B, and an electronic sticky note terminal 250C are provided in a conference room. 280A, and a gathering is held. The electronic sticky note control apparatus 100A, the electronic sticky note terminal 250A, the electronic sticky note terminal 250B, and the electronic sticky note terminal 250C are connected to one another via a communication line 298. The communication line 298 may be of a wireless-type, a wired-type, or a combination thereof, and may be, for example, the Internet or the Intranet as a communication infrastructure.

In addition, an electronic sticky note control apparatus 100B, an electronic sticky note terminal 250D, and an electronic sticky note terminal 250E are provided in a conference room. 280B, and a gathering is held. The electronic sticky note control apparatus 100B, the electronic sticky note terminal 250D, and the electronic sticky note terminal 250E are connected to one another via the communication line 298.

In addition, a user terminal 210A, a user terminal 210B, a task management device 220, a sticky note information storage device 294, the devices in the conference room 280A, and the devices in the conference room 280 are connected to one another via a communication line 299. In addition, the functions of the task management device 220 and the sticky note information storage device 294 may be implemented as a cloud service.

The task management device 220 is a system that manages tasks of a project and performs the management of tasks in cooperation with the electronic sticky note control apparatus 100. For example, when it is detected that there is a sticky note corresponding to a task, the electronic sticky note control apparatus 100 notifies the task management device 220 which is concerned with the project, that the task occurs. In addition, when a change occurs in the sticky note (for example, determination of a person who is in charge of the task or the progress status), the electronic sticky note control apparatus 100 notifies the task management device 220 that a change in the task occurs. Then, the task management device 220 may manage the corresponding task. Conversely, when a change occurs in the task corresponding to the sticky note, the task management device 220 may notify the electronic sticky note control apparatus 100 that a change occurs in the sticky note, and may cause the electronic sticky note control apparatus 100 to manage the sticky note corresponding to the task.

In addition, the task management device 220 may not be provided. The electronic sticky note control apparatus 100 may manage the tasks.

The sticky note information storage device 294 stores information on sticky notes. Each electronic sticky note control apparatus 100 performs processes using the sticky note information storage device 294. In this case, the information on sticky notes in the sticky note information storage device 294 may be shared by plural electronic sticky note control apparatuses 100. That is, information on a sticky note managed by the electronic sticky note control apparatus 100A may be used by the electronic sticky note control apparatus 100B. In particular, when plural gatherings are involved in one project (for example, gatherings in the conference room 280A and the conference room 280B), a sticky note corresponding to the same task may be pasted on a mount in another gathering. This enables the status of the same task in one gathering to be grasped in the other gathering.

FIGS. 3A to 3C are explanatory views illustrating use examples of the electronic sticky note terminal 250 and the electronic sticky note control apparatus 100 in a conference room or the like in which the present exemplary embodiment is used.

As illustrated in the example of FIG. 3A, participants 311 and 312 and a facilitator 321 gather in a conference room or the like. The participant 311 uses the electronic sticky note terminal 250A, and the participant 312 uses the electronic sticky note terminal 250B. Generally, one terminal device (for example, the electronic sticky note terminal 250A) is given to one participant. Like the electronic sticky note terminal 250 illustrated in the example of FIG. 3C, the terminal device is a tablet terminal having the size of a notebook (for example, A4, B5, or 7 to 10 inches) and is operated using a finger, a pen, or the like. Sticky note information in which text data, handwritten characters, figures, and the like are written is created by the participants. In addition, the terminal device is not limited to the tablet terminal, but may be a PC (including a notebook PC) or the like having a keyboard, a mouse, and the like.

An electronic sticky note control apparatus 100x illustrated in the example of FIG. 3A is a projector that displays mounts and sticky notes. In addition, an electronic sticky note control apparatus 100y is an electronic whiteboard that receives an operation of pasting a sticky note to a mount (table), an operation of moving the sticky note, an operation of linking (grouping) sticky notes to each other, or the like by detecting the movement of the finger, the pen or the like of the facilitator 321. For example, the electronic sticky note control apparatus 100y is provided with a pen, and receives an operation for the mounts and the sticky notes by detecting that the pen is separated from a predetermined pen holder (that the facilitator 321 lifts the pen to operate the pen) and by detecting a position of the tip of the pen (for example, the pen tip comes into contact with the electronic sticky note control apparatus 100y). For example, a sensor (for example, a sensor having a switch turned on/off by the weight of the pen) may be provided on the pen holder, and a used pen may be detected from among plural pens (for example, a black pen, a red pen, and a blue pen). In addition, the entire display screen of the electronic sticky note control apparatus 100y may be a touch sensor that may detect a contact position and pressure on the display screen. In the present example, although the On/Off of the pen is controlled by the pen holder, the pen holder may not be provided. The On/Off of the pen may be directly controlled from the pen side. Change in color may require no pen holder. A color palette may be provided on a part of the display screen so that color is changed when the pen (or a thing similar to the pen) touches a target color. Alternatively, the pen may have a function of instructing a change in color (for example, a button or a slider).

In addition, the electronic sticky note control apparatus 100 may be an electronic board as illustrated in the example of FIG. 3B. In general, the electronic board generally includes a large-screen display device (at least larger than the display device of the electronic sticky note terminal 250), and the display device is a touch panel that detects a touch position and pressure on the display screen. For example, the screen may have a size of 80 inches or the like.

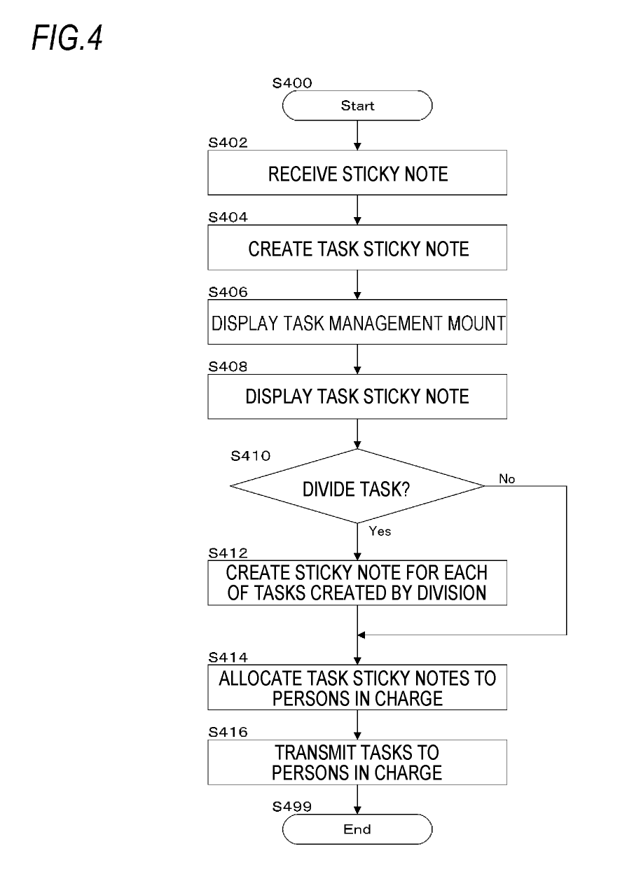

FIG. 4 is a flowchart illustrating a process example according to the present exemplary embodiment.

In step S402, a task is received. The task may be received from other people (for example, a superior). Alternatively, a user may designate a sticky note on a mount as the task. For example, task information 500 is received. FIG. 5 is an explanatory view illustrating a data structure example of the task information 500. The task information 500 includes a task ID column 510, a task content column 515, a person-in-charge column 520, a delivery date column 525, and a status column 530. In the present exemplary embodiment, the task ID column 510 stores information (task identification (ID)) for uniquely identifying a task. The task content column 515 stores the content of the task. The person-in-charge column 520 stores a person in charge of the task. The delivery date column 525 stores a delivery date of the task. The status column 530 stores a status of the task.

In step S404, a task sticky note is created in accordance with the task received in step S402. For example, the sticky note information table 600 is created. FIG. 6 is an explanatory view illustrating a data structure example of the sticky note information table 600. The sticky note information table 600 includes a sticky note ID column 610, a pasting position column 615, a size column 620, a creation date and time column 625, a creator column 630, a pasting date and time column 635, a color column 640, a frame line shape column 645, a frame line color column 650, a frame line thickness column 655, a belonging group column 660, a task flag column 665, a content type column 670, and a content column 675. The sticky note ID column 610 stores information (sticky note ID) for uniquely identifying the sticky note in the present exemplary embodiment. The pasting position column 615 stores a position where the sticky note is pasted. That is, the pasting position column 615 stores the pasting position on the mount. For example, the pasting position is the coordinates in the XY coordinate system on the mount. The size column 620 stores the size of the sticky note. For example, when the sticky note to be displayed has a rectangular shape, the size column 620 stores the width and the height of the sticky note. The creation date and time column 625 stores the date and time (year, month, day, hour, minute, second, sub-second, or a combination thereof) when the sticky note is created. The creator column 630 stores a creator (creator ID) of the sticky note. Alternatively, the creator column 630 may store an information processing apparatus (an apparatus ID of the electronic sticky note terminal 250 or the electronic sticky note control apparatus 100) with which the sticky note is created. The pasting date and time column 635 stores the date and time when the sticky note is pasted on the mount. The color column 640 stores the display color of the sticky note. The frame line shape column 645 stores the shape of the frame line (for example, a solid line, a dotted line, a broken line, a wavy line, or a double line) in the display of the sticky note. The frame line color column 650 stores the color of the frame line in the display of the sticky note. The frame line thickness column 655 stores the thickness of the frame line in the display of the sticky note. The belonging group column 660 stores information on a group to which the sticky note belongs. For example, the belonging group column 660 may store information indicating whether or not the sticky note belongs to the group. If the sticky note belongs to the group, the belonging group column 660 may store the group ID or other sticky note IDs which belong to the group. The task flag column 665 stores information (flag) indicating whether or not there is a task that corresponds to the sticky note. For example, the task flag column 665 stores either of an ON-state (a flag state indicating that there is a task that corresponds to the sticky note) or an OFF-state (a flag state indicating that there is no task corresponding to the sticky note, that is, a flag state indicating that the sticky note is a general sticky note). The content type column 670 stores a content type of the sticky note (text information, vector data indicating handwritten characters, figures or the like, voice information, still image information such as a photograph, moving image information, or the like, or information indicating a combination thereof). The content column 675 stores contents written in the sticky note.

In addition, if a value of the task flag column 665 of the sticky note information table 600 illustrated in the example of FIG. 6 is “ON”, the sticky note task information 700 is added after the content column 675. FIG. 7 is an explanatory view illustrating a data structure example of the sticky note task information 700. The sticky note task information 700 includes a task content column 710, a person-in-charge column 715, a delivery date column 720, and a status column 725. The task content column 710 stores the content of the task. In addition, the task content column 710 may store a flag indicating whether concurrent working is possible. This flag is used to determine whether or not a copy operation of the sticky note is permitted. The person-in-charge column 715 stores a person in charge of the task. The delivery date column 720 stores the delivery date of the task. The status column 725 stores the status (progress state) of the task.

In step S406, a task management mount is displayed. For example, the mount is managed using the mount information table 800. FIG. 8 is an explanatory view illustrating a data structure example of the mount information table 800. The mount information table 800 includes a mount ID column 810, a mount pattern ID column 815, a creation date and time column 820, and a creator column 825. In the present exemplary embodiment, the mount ID column 810 stores information (mount ID) for uniquely identifying the mount. The mount pattern ID column 815 stores a mount pattern ID as the background. For example, there are a white paper pattern, a tabular pattern, a pattern having a sticky note pasting area for each general-purpose sticky note, and the like. Moreover, a mount pattern may be, for example, a mount pattern for task management. Specifically, an area in which a portrait icon of a gathering participant (who may be a person in charge of the task) may be defined in advance, and the icon may be drawn at a point in time when the gathering participant is determined. A sticky note in which self-introduction of the gathering participant is written may be used as a substitute for the icon. Moreover, as a mount for an administrator, a schedule table in which a horizontal axis represents date and time and the respective participants are allocated on the vertical axis may be prepared. With this schedule table mount, schedules and persons in charge are intuitively grasped on the mount. In addition, the schedule table mount may be prepared so that the administrator sets the priorities of tasks possessed by the persons in charge. The creation date and time column 820 stores the creation date and time of the mount. The creator column 825 stores a creator of the mount.

Then, for example, the mount 900 as illustrated in FIG. 9 is displayed. The mount 900 is a task management mount. A member (me) area 910, a member B area 920, a member C area 930, and a member D area 940 are displayed on the mount 900. For example, it is assumed that member B, member C and member D are subordinates. The task (sticky note) is managed by creating, pasting, moving, editing, or deleting the sticky note on the mount 900.

In step S408, the task sticky note is displayed on the mount displayed in step S406.

For example, the task sticky note 950 is pasted on the member (me) area 910 illustrated in FIG. 9. The task sticky note 950 is a sticky note with which a task is associated (specifically, the task flag column 665 is “ON” and the sticky note task information 700 is added). That is, a task “Preparation for release” is allocated to myself. This is an example in which a sticky note (task sticky note 950) indicating a task possessed by the user is displayed within a predetermined range from an object that indicates the user (within the member (me) area 910).

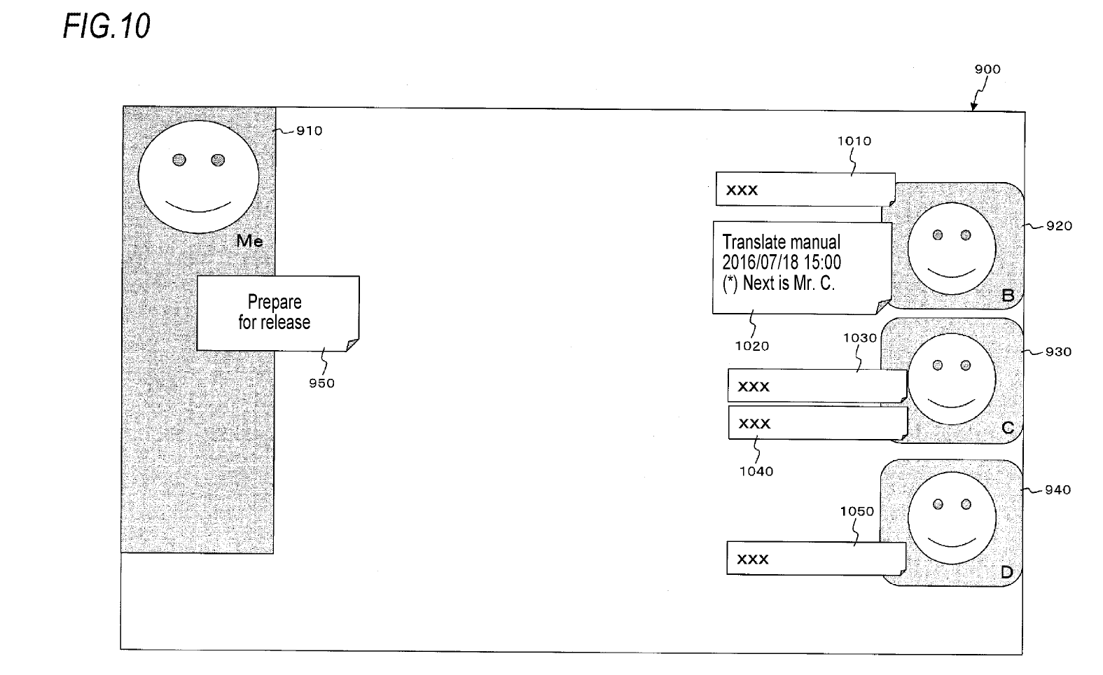

Then, as illustrated in an example of FIG. 10, a task sticky note 1010 and a task sticky note 1020 may be pasted on the member B area 920 by a user operation. Thereby, the tasks are allocated to the member B. In addition, in a mount managed by the member B, the task sticky note 1010 and the task sticky note 1020 are pasted on an him/herself (the member B) area. For example, in the task sticky note 1020, “Translate manual 2016/07/18 15:00 (*) Next is Mr. C” is written as contents.

In addition, a task sticky note 1030 and a task sticky note 1040 may be pasted on the member C area 930. Thereby, the tasks are allocated to the member C. In addition, in a mount managed by the member C, the task sticky note 1030 and the task sticky note 1040 are pasted on a him/herself (the member C) area.

In addition, if a task has already been allocated to the member D, a task sticky note 1050 is pasted on the member D area 940. Of course, in a mount managed by the member D, the task sticky note 1050 has already been pasted on a him/herself (the member D) area.

Also, assuming that plural workers perform one task. In this case, upon completion of one worker's work, he/she hand over the task to a user of a subsequent process. That is, the handover of the task is implemented by moving a sticky note that corresponds to the task to the area of the other user. Of course, the sticky note disappears from the one worker's area, and this means that the one worker is no longer in charge of the task. In addition, in a mount managed by the user who has received the moved sticky note, the sticky note of the task is pasted on a his/her area (he/she is the user who has received the moved sticky note).

In addition, when the task is concurrently performed, the task is copied (so that two or more sticky notes are created) and is transmitted to each user. As a result, the task is added under the management of the user who has received the sticky note. That is, this is implemented by copying the sticky note corresponding to the task to the area of another user. Of course, the sticky note remains in the copy source area, and this means that a user of the copy source area is continuously in charge of the task. Then, in the mount of the user who has received the sticky note, the sticky note of the task is pasted on a his/her area.

In step S410, it is determined whether to divide a task, based on a user operation. If it is determined to divide the task, the process proceeds to step S412. Otherwise, the process proceeds to step S414.

In step S412, a task sticky note for each of the tasks created by the division is created.

In step S414, task sticky notes are allocated to persons in charge.

In step S416, the tasks created by the division are transmitted to the persons in charge. For example, the sticky notes of the tasks may be sent by e-mail, or the sticky notes of the tasks may be pasted on the task management mounts managed by the respective persons in charge.

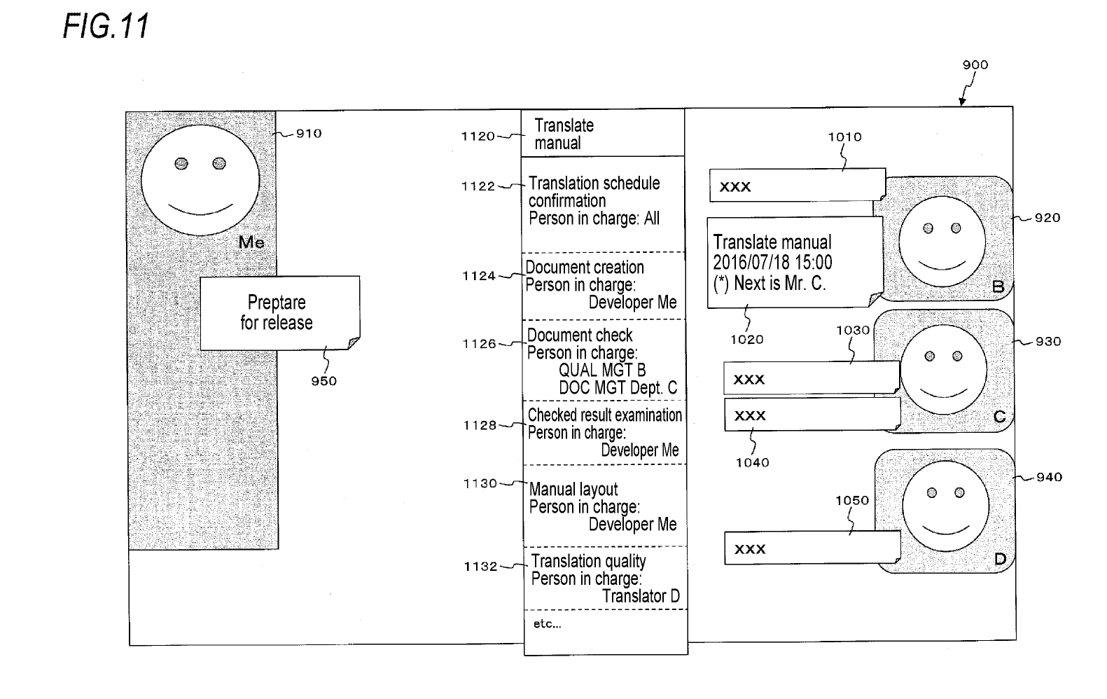

For example, if the task sticky note 1020 is selected as a task division target as illustrated in FIG. 11, division candidates of the task sticky note 1020 are displayed on a task division candidate display area 1120. In the task division candidate display area 1120, a task division candidate 1122 “Translation schedule confirmation Person in charge: All”, a task division candidate 1124 “Document creation Person in charge: Developer Me”, a task division candidate 1126 “Document check Person in charge: QUAL MGT B, DOC MGT Dept. C”, a task division candidate 1128 “Checked result examination Person in charge: Developer Me”, a task division candidate 1130 “Manual layout Person in charge: Developer Me”, and a task division candidate 1132 “Translation request Person in charge: Translator D” are displayed.

Thereafter, a task division candidate is selected so that new sticky notes (that corresponds to a task division) are created, and the sticky notes are pasted on areas that indicate persons in charge (this corresponds to task allocation).

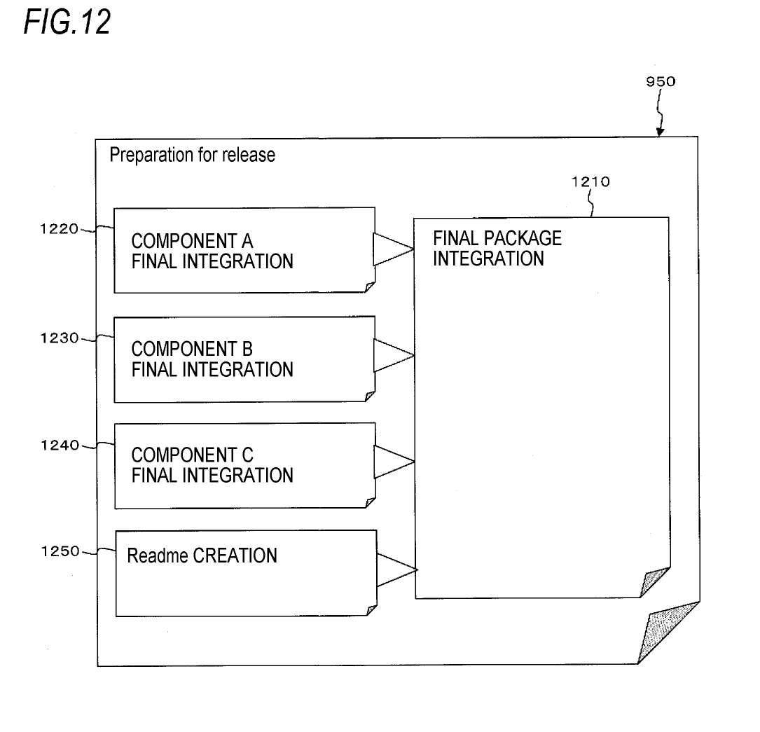

Generally, a project is divided into subcomponents on an appropriate scale, and a sub-team is in charge of each subcomponent. A work place of the sub-team serves the concept of “mount”. As a user interface that expresses a sticky note with which a task is associated, there are (1) a user interface for assigning a task to a person in charge by a mount and a sticky note illustrated in the example of FIGS. 9 to 11 and (2) a user interface for visualizing a relationship between tasks as illustrated in the example of FIG. 12.

In the user interface of (2), the subdivided tasks are expressed as sticky notes, the following elements are required when a sticky note is created.

Task Title, Content, and Delivery Date

It should be noted that the delivery date is set automatically. If there is no master task or if there is not a depending task or a depended task, the delivery date is the same as the final delivery date of the subcomponent. In addition, another custom value may be input.

If there is a master task, the delivery date is the same as the delivery date of the master task. In addition, if there is a depending task, the delivery date of the depending task becomes the start date. If there is a depended task, the delivery date is before the start date of the depended task.

A relationship between tasks is visually represented as illustrated in an example of FIG. 12.

In an example of FIG. 12, in the task sticky note 950 “Preparation for release”, a task sticky note 1210 “Final package integration”, a task sticky note 1220 “A component final integration”, a task sticky note 1230 “B component final integration”, a task sticky note 1240 “C component final integration”, and a task sticky note 1250 “Readme creation” are pasted.

FIG. 12 shows that “Preparation for release” of the task sticky note 950 is a master task and that the task sticky note 1210, the task sticky note 1220, the task sticky note 1230, the task sticky note 1240, and the task sticky note 1250 in the task sticky note 950 are subtasks (the task sticky note 1220, the task sticky note 1230, the task sticky note 1240, and the task sticky note 1250 are descendant tasks for the task sticky note 950). With respect to the task sticky note 1210, the task sticky note 1220, the task sticky note 1230, the task sticky note 1240, and the task sticky note 1250 are depending tasks. Conversely, with respect to the task sticky note 1220, the task sticky note 1230, the task sticky note 1240, and the task sticky note 1250, the task sticky note 1210 is a depended task.

Therefore, the delivery date of the task that corresponds to the task sticky note 1210 is the same as the delivery date of the task sticky note 950 that is the master task. Then, the start date of the task is the same as the date when all of the task sticky note 1220, the task sticky note 1230, the task sticky note 1240, and the task sticky note 1250, which are depending tasks, are completed (that is, the final end date of these tasks).

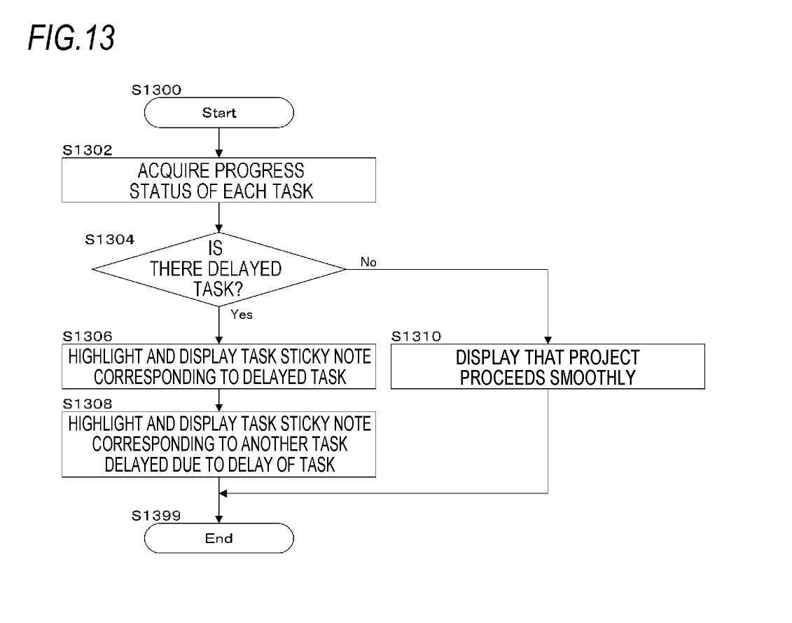

FIG. 13 is a flowchart illustrating a process example according to the present exemplary embodiment. This is a process of displaying the influence on the entire project in conjunction with an operation of transmitting a task in the form of a sticky note. That is, tasks possessed by persons in charge, a dependence relationship between tasks, a critical path, and the like are visually grasped by expression using sticky notes.

In step S1302, the progress status of each task is acquired.

In step S1304, it is determined whether or not there is a delayed task. If there is a delayed task, the process proceeds to step S1306. Otherwise, the process proceeds to step S1310.

In step S1306, a task sticky note that corresponds to the delayed task is highlighted and displayed.

In step S1308, a task sticky note that corresponds to another task delayed due to the delay of the task is highlighted and displayed.

In step S1310, the status in which the project proceeds smoothly is displayed.

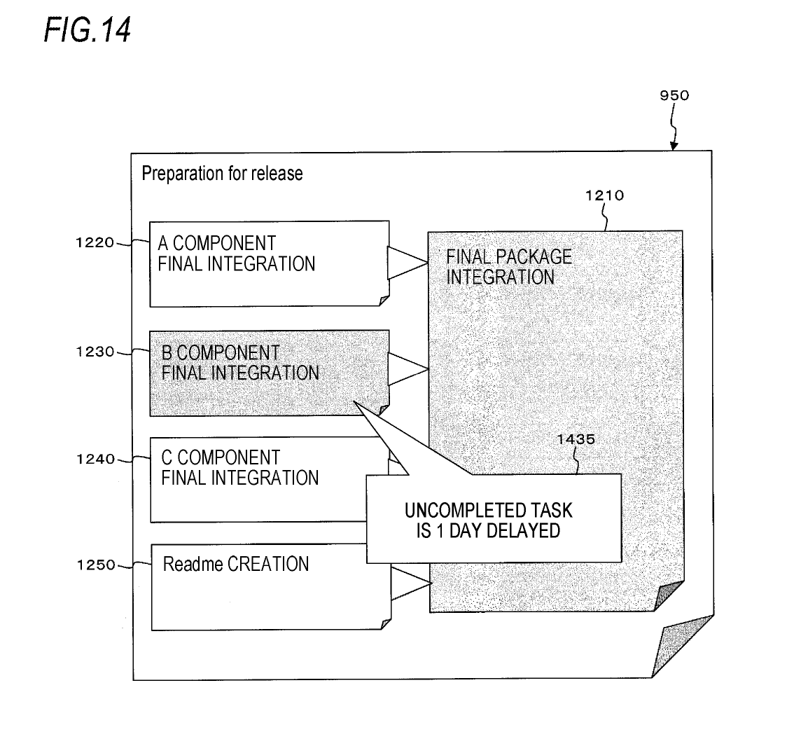

For example, the display state illustrated in FIG. 12 may be changed to the state illustrated in FIG. 14. FIG. 14 illustrates that a task that corresponds to the task sticky note 1230 is delayed. The task sticky note 1230 is changed to a color (for example, red) which is different from those of the other sticky notes, and a message 1435 “Uncompleted task is delayed 1 day” is displayed near the task sticky note 1230. In addition, the task sticky note 1210 which corresponds to a task depending on the task sticky note 1230 is also changed to a color (for example, red) which is different from those of the other sticky notes. Since the task sticky note 1230 which is a depending task is delayed, the task sticky note 1210 is also delayed.

In addition, the electronic sticky note control apparatus 100 calculates a bottleneck task, a critical path, and the like, and changes the shape of a sticky note corresponding thereto so as to give a warning to the user (for example, a person in charge or an administrator). In addition, examples of a change in form include a change in color, shape, pattern or the combination thereof, or a dynamic change thereof (for example, flash or animation).

In addition, the status of such a warning or delay is also notified to concerned persons of tasks that depends on the delayed task.

Then, in response to such a warning or the like, the administrator may perform an operation of assigning the delayed task to another worker or reconstructing a dependency relationship so as to minimize the influence on the entire schedule. Alternatively, the electronic sticky note control apparatus 100 may display a proposal so that the administrator may select the proposal.

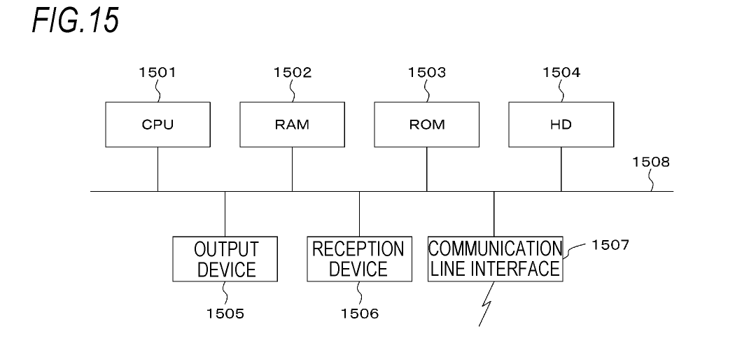

In addition, a hardware configuration of the computer in which the program according to the present exemplary embodiment is executed is a general computer, as illustrated in FIG. 15. Specifically, the computer may be a personal computer or a server. That is, as a specific example, the hardware configuration uses the CPU 1501 as a processing unit (arithmetic unit), and uses a RAM 1502, a ROM 1503, and an HD 1504 as storage devices. As the HD 1504, for example, a hard disk or a solid state drive (SSD) may be used. The hardware configuration includes the CPU 1501 that executes programs of the mount creation module 110, the sticky note creation module 120, the task management module 125, the task-per-person allocation module 130, the communication module 135 and the like, the RAM 1502 that which stores the programs or data, the ROM 1503 that stores the programs and the like to start the computer, the HD 1504 that is an auxiliary storage device (for example, a flash memory) having functions as the mount information storage module 105 and the sticky note information storage module 115, a reception device 1506 that receives data based on a user operation (including a motion, voice, gaze, or the like) on a keyboard, a mouse, a touchscreen, a microphone, a camera (including a camera that detects gaze) or the like, an output device 1505 such as a CRT, a liquid crystal display or a speaker, a communication line interface 1507 for connection of a communication network such as a network interface card, and a bus 1508, which interconnects them to enable data exchange. Plural computers may be connected to each other by a network.

Among the above-described exemplary embodiments, with regard to those based on the computer program, a system of the hardware configuration reads the computer program which is software, and the above-described exemplary embodiments are implemented via the cooperation of software and hardware resources.

In addition, the hardware configuration illustrated in FIG. 15 illustrates one configuration example. The present exemplary embodiment is not limited to the configuration illustrated in FIG. 15, and may include any configuration so long as it may execute the module described in the present exemplary embodiment. For example, some of the modules may be configured with dedicated hardware (for example, an application specific integrated circuit (ASIC) or the like), and some of the modules may be provided in an external system and may be connected to one another via a communication line. Moreover, plural systems illustrated in FIG. 15 may be connected to each other via a communication line so as to cooperate with each other. In addition to a personal computer, in particular, the computer may be inserted into a portable information communication device (including a cellular phone, a smart phone, a mobile device, a wearable computer and the like), an information home appliance, a robot, a copy machine, a fax machine, a scanner, a printer, a multifunction machine (an image processing apparatus having any two or more functions of the scanner, the printer, the copy machine, and the fax machine), or the like.

In addition, the program described above may be provided by being stored in a recording medium, or may be provided by a communication device. In that case, for example, the above-described program may be regarded as the invention of “a computer readable recording medium in which a program is recorded”.

The “computer readable recording medium in which a program is recorded” refers to a computer readable recording medium in which a program is recorded, which is used for installation, execution, distribution and the like of programs.

In addition, examples of the recording medium include a digital versatile disc (DVD) such as “DVD-R, DVD-RW, DVD-RAM or the like” that is the standard set in a DVD forum and “DVD+R, DVD+RW or the like” that is the standard set in a DVD+RW, a compact disc (CD) such as a read only memory (CD-ROM), a CD recordable (CD-R) and a CD rewritable (CD-RW), a Blu-ray (registered trademark) disc, a magneto-optical disc (MO), a flexible disc (FD), a magnetic tape, a hard disk, a read only memory (ROM), an electrically erasable and rewritable read only memory (EEPROM (registered trademark)), a flash memory, a random access memory (RAM), a secure digital (SD) memory card, and the like.

In addition, the whole part or a part of the program may be recorded on the recording medium to thereby be stored or circulated. In addition, transmission may be performed via communication using a transmission medium, for example, a wired network that is used in a local area network (LAN), a metropolitan area network (MAN), a wide area network (WAN), the Internet, the Intranet, the Extranet or the like, a wireless communication network, or a combination thereof, or the like, or may be carried on a carrier wave.

In addition, the program may be a part or the whole part of another problem, or may be recorded on a recording medium together with a separate program. In addition, the program may be divided and recorded in plural recording media. In addition, the program may be recorded in any other manner such as compression or encryption as long as it can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiver configured to receive, as a task, a sticky note that can be pasted on a mount;
a processing unit configured to process the sticky note on the mount; and
a transmitter configured to transmit the processed sticky note to a person who is in charge of a task indicated by the sticky note.

2. The information processing apparatus according to claim 1, wherein
the processing unit is configured to perform a process of dividing the task by dividing the sticky note into a plurality of new sticky notes, and
the transmitter is configured to transmit the new sticky notes to persons who are in charge of tasks indicated by the new sticky notes.

3. The information processing apparatus according to claim 2, wherein a delivery date of tasks corresponding to the new sticky notes are determined in accordance with a delivery date of the task.

4. The information processing apparatus according to claim 1, further comprising:
a display configured to display a progress status of the task corresponding to the sticky note transmitted by the transmitter.

5. The information processing apparatus according to claim 4, wherein the progress status includes the number of sticky notes associated with the task and a residence time.

6. The information processing apparatus according to claim 1, further comprising:
a setting unit, wherein when an operation of moving a sticky note toward an object that indicates a user, the setting unit sets the user indicated by the object as a person who is in charge of a task indicated by the moved sticky note.

7. The information processing apparatus according to claim 6, further comprising:
a display configured to display a sticky note that indicates a task possessed by the user within a predetermined range from the object that indicates the user.

8. An information processing apparatus comprising:
receiving means for receiving, as a task, a sticky note that can be pasted on a mount;
processing means for processing the sticky note on the mount; and
transmitting means for transmitting the processed sticky note to a person who is in charge of a task indicated by the sticky note.
